(19) United States
(12) Patent Application Publication
(10) Pub. No.: US 2016/0188127 A1
(43) Pub. Date: Jun. 30, 2016

(54) COMMUNICATION DEVICE AND METHOD FOR PROCESSING MESSAGE OF THE COMMUNICATION DEVICE

(71) Applicant: FIH (HONG KONG) LIMITED, Kowloon (HK)

(72) Inventor: WANG-HUNG YEH, New Taipei (TW)

(21) Appl. No.: 14/750,291

(22) Filed: Jun. 25, 2015

(30) Foreign Application Priority Data
Dec. 30, 2014 (TW) 103146310

(51) Int. Cl. G06F 3/0482; G06F 3/0488; G06F 3/0481

(52) U.S. Cl. CPC G06F 3/0482; G06F 3/04817; G06F 3/0488

(57) ABSTRACT

In a message processing method for a communication device the communication device displays an integration interface on the touch screen, and displays an addition box including an addition button on the integration interface when an integration button of the integration interface is triggered. When the addition button is triggered, a menu bar containing icons of applications is displayed on the integration interface. Any icon selected from the menu bar is added into the addition box. When a sending button of the integration interface is triggered, a previously input message in an information input box of the integration interface is sent to a selected contact using the application corresponding to the selected icon.

### CROSS-REFERENCE TO RELATED APPLICATIONS

This application claims priority to Taiwan Patent Application No. 103146310 filed on Dec. 30, 2014, the contents of which are incorporated by reference herein.

### FIELD

The subject matter herein generally relates to information processing technology, and particularly to a communication device and method for processing messages of the communication device.

### BACKGROUND

Instant messaging (IM) applications of a communication device provide an online chat service which offers real-time text transmission over a network (for example, the Internet or other types of networks). Different IM applications have different icons. If a user of the communication device wants to view or reply to a message using an IM application, the user needs to first click an icon of the IM application to enter the IM application. If different contacts communicate with the user using different IM applications, the user needs to view and reply to the different contacts by frequently switching between the different IM applications.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of a communication device.

FIG. 2 is a block diagram of an example embodiment of a message processing system included in the communication device of FIG. 1.

FIG. 3 is a diagrammatic view of an example embodiment of a preset user interface for the method of sending the messages.

FIG. 4 is a diagrammatic view of an example embodiment of an addition box of the preset user interface for the method of sending the messages.

FIG. 5 is a diagrammatic view of an example embodiment of displaying virtual keystrokes of communication applications for the method of sending the messages.

FIG. 6 is a diagrammatic view of an example embodiment of adding virtual keystrokes of communication applications for the method of sending the messages.

FIG. 7 is a diagrammatic view of an example embodiment of sending message using the communication applications corresponding to the added virtual keystrokes.

FIG. 8 is a diagrammatic view of an example embodiment of the preset user interface when receiving messages for the method of replying to the messages.

FIG. 9 is a diagrammatic view of an example embodiment of replying to the messages using the communication applications corresponding to the added virtual keystrokes.

FIG. 10 is a diagrammatic view of an example embodiment of replying to the messages in a default mode.

FIG. 11 is a flowchart of an example embodiment of a method for sending messages from the communication device of FIG. 1.

FIG. 12 is a flowchart of an example embodiment of a method for replying to messages of the communication device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules can be embedded in firmware, such as in an erasable programmable read only memory (EPROM). The modules described herein can be implemented as either software and/or computing modules and can be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series, and the like.

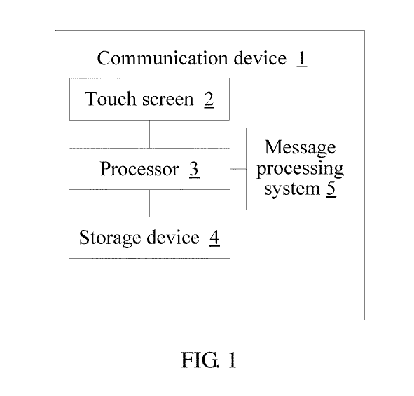

FIG. 1 illustrates a block diagram of an example embodiment of a communication device. In at least one embodiment, as shown in FIG. 1, a communication device 1 can include, but is not limited to, a touch screen 2, at least one processor 3, a storage device 4, and a message processing system 5. FIG. 1 illustrates only one example of the communication device 1, other examples can comprise more or fewer components than those shown in the embodiment, or have a different configuration of the various components.

The touch screen 2 can display various types of data of the communication device 1, and various user interfaces of the communication device 1. The touch screen 2 can receive input from a user of the communication device 1, for example, finger touch operations on the touch screen 2. In some embodiments, the touch screen 2 can be a resistive touch screen or a capacitive touch screen.

The at least one processor 3 executes one or more computerized codes and other applications of the communication device 1 to provide functions of the communication device 1. The storage device 4 stores one or more applications and data of the communication device 1. In at least one embodiment, the storage device 4 can be an internal storage device, such as a random access memory (RAM) for temporary storage of information, and/or a read only memory (ROM) for permanent storage of information. The storage device 4 can also be an external storage device, such as an external hard disk, a storage card, or a data storage medium.

In at least one embodiment, the applications are instant messaging (IM) software, such as QQ™ and Microsoft Service Network (MSN), for example. In at least one embodiment, each of the applications has a corresponding icon. The user of the communication device 1 can use an account and a password to log on to each application. The applications can send and receive messages to and from other communication devices (not shown) over a network.

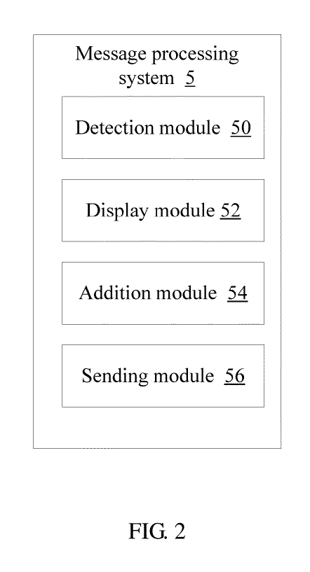

In at least one embodiment, the message processing system 5 can include, but is not limited to, a detection module 50, a display module 52, an addition module 54, and a sending module 56, as shown in FIG. 2. The modules 50, 52, 54, and 56 can include computerized instructions in the form of one or more computer-readable programs that can be stored in a non-transitory computer-readable medium, such as the storage device 4, and be executed by the at least one processor 3 of the communication device 1. A description of each module of the message processing system 5 is given in the following paragraphs.

When the communication device 1 wants to send a message, the detection module 50 detects whether a preset integration keystroke is triggered. In one embodiment, the preset integration keystroke can be a physical keystroke, a virtual keystroke, or a combination of the physical keystroke and virtual keystroke. When the preset integration keystroke is pressed or clicked, the detection module 50 determines that the preset integration keystroke is triggered.

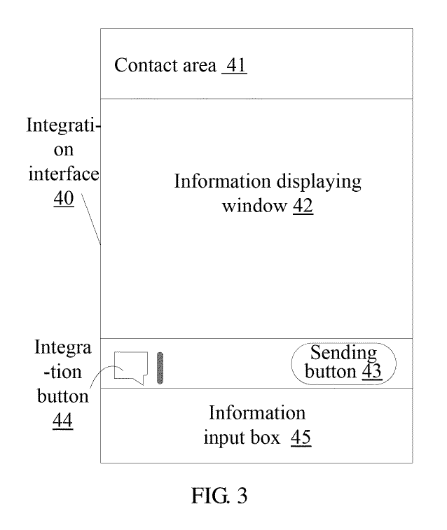

When the preset integration keystroke is triggered, the display module 52 displays an integration interface on the touch screen 2. As shown in FIG. 3, an integration interface 40 includes, but is not limited to, a contact area 41, an information displaying window 42, a sending button 43, an integration button 44, and an information input box 45. The user can select a contact from one of the applications to be displayed in the contact area, and further can input a message to the contact in the information input box 45. The information displaying window 42 can display messages transmitted to or received from the contact. FIG. 3 illustrates only one example of the integration interface, other examples can comprise more or fewer components than those shown in the embodiment, or have a different configuration of the various components.

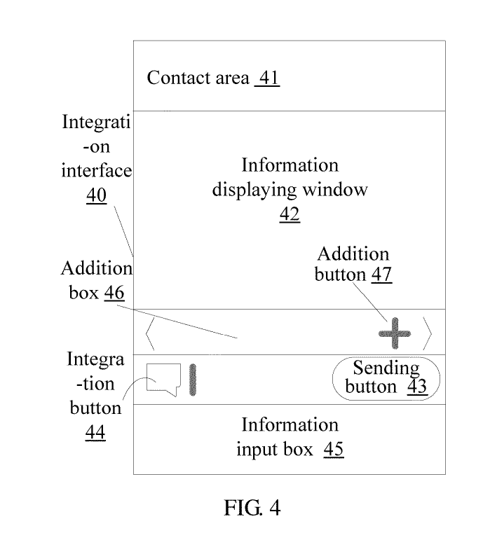

As shown in FIG. 4, the display module 52 displays an addition box 46 on the integration interface 40 when the integration button 44 is triggered. The addition box 46 includes an addition button 47. The addition button 47 is displayed as “+” in the addition box 46.

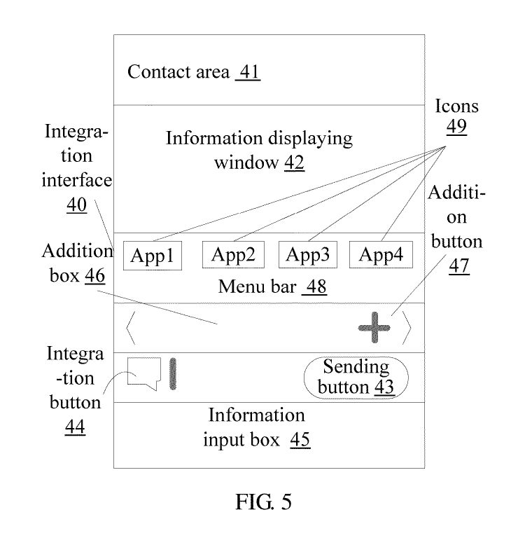

As shown in FIG. 5, when the addition button 47 is triggered, the display module 52 displays a menu bar 48 on the integration interface 40, displayed above the addition box 46. In at least one embodiment, the menu bar 48 includes the icons 49 of each of the applications. The display position of the menu bar is above the display position of the addition box 46, and the icons 49 include icons named “APP1”, “APP2”, “APP3”, and “APP4”.

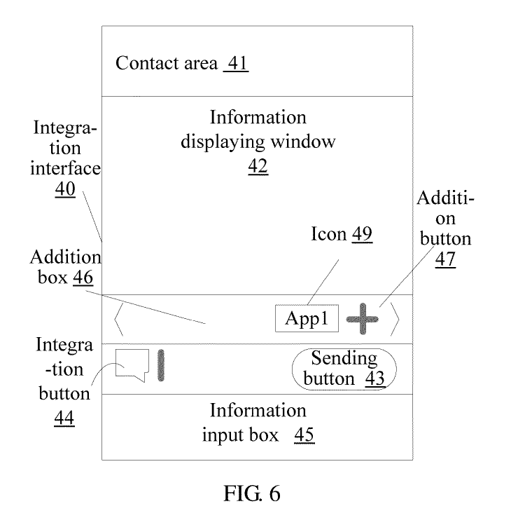

As shown in FIG. 6, when one of the icons 49 in the menu bar 48 is selected to be triggered, the addition module 54 adds the selected icon 49 into the addition box 46. If the user clicks the icon named “APP1”, the addition module 54 adds the icon named “APP1” to the display in the addition box 46.

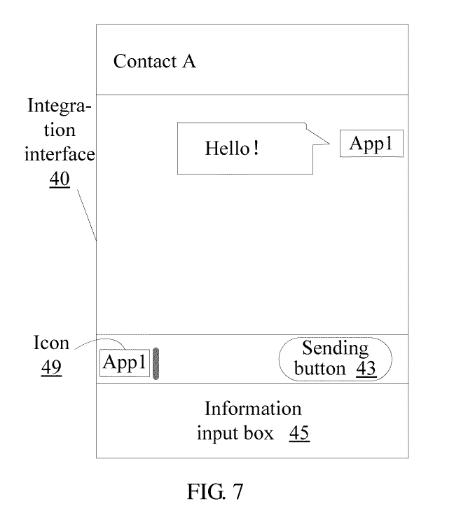

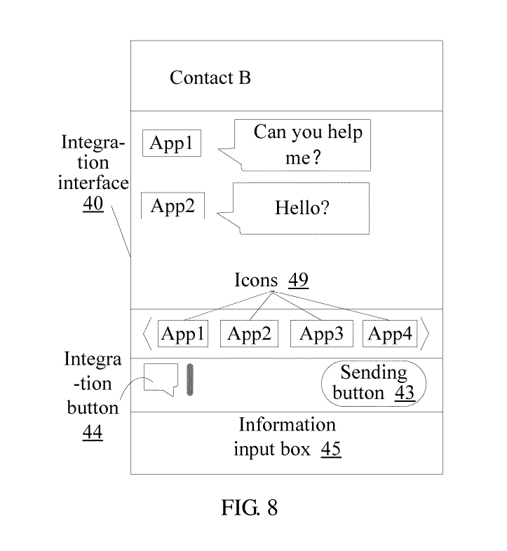

As shown in FIG. 7, when the sending button 43 is triggered, the sending module 56 sends a message in the information input box 45 using an application corresponding to the selected icon 49, to a selected contact from the contact area. The sending module 56 uses the application corresponding to the selected icon named “APP1” to send a message “hello!” which has been input in the information input box 45 to the contact “A”. It should be understood, if the user wants to use another application to send a message to the contact, the user can click the selected icon as shown in FIG. 8 and the display module 52 reverts to displaying the addition box 46 including the addition button 47 on the integration interface 40.

When the communication device 1 receives a message of a contact from one or more applications of another communication device, and the user wants to reply to the contact, the user can press the integration button 44 to trigger the integration button 44. The user then selects one of the icons 49 to be added into the addition box 46, and sends the message in the information input box 45 using an application 4 corresponding to the added icon 49. If the integration button 44 is not triggered, the sending module 56 sends the message in reply to the contact in the information input box 45 in a default mode. For example, if the communication device 1 receives the latest message of the contact from the application corresponding to the icon named “APP1”, the sending module 56 uses the application corresponding to the icon named “APP1” to send the message in reply.

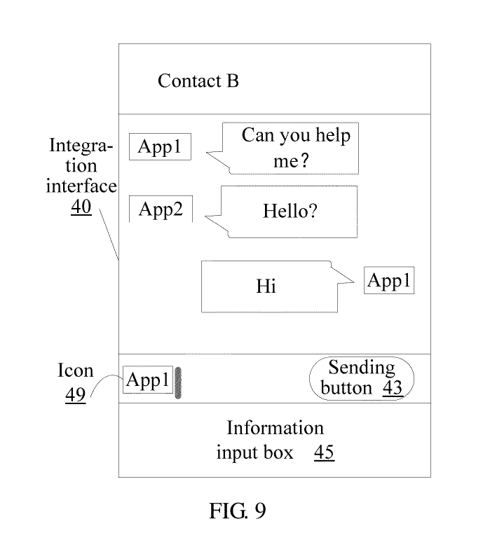

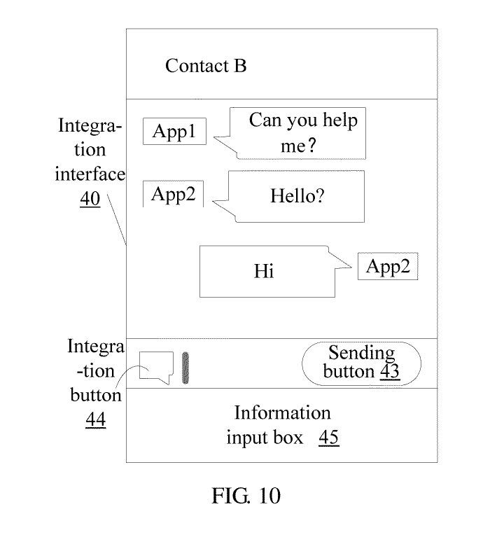

As shown in FIG. 8, the information displaying window 42 displays two messages from a contact “B” sent via two different applications from at least one other communication device. As shown in FIG. 9, when the integration button 44 is not triggered, and the icon named “APP1” is triggered, the sending module 56 sends a message “hi” using the application corresponding to the icon named “APP1” to reply to the contact “B”. As shown in FIG. 10, when the integration button 44 is not triggered, and the latest message is received via the application corresponding to the icon named “APP2”, the sending module 56 uses the application corresponding to the icon named “APP2” to send the message in reply to the contact “B”.

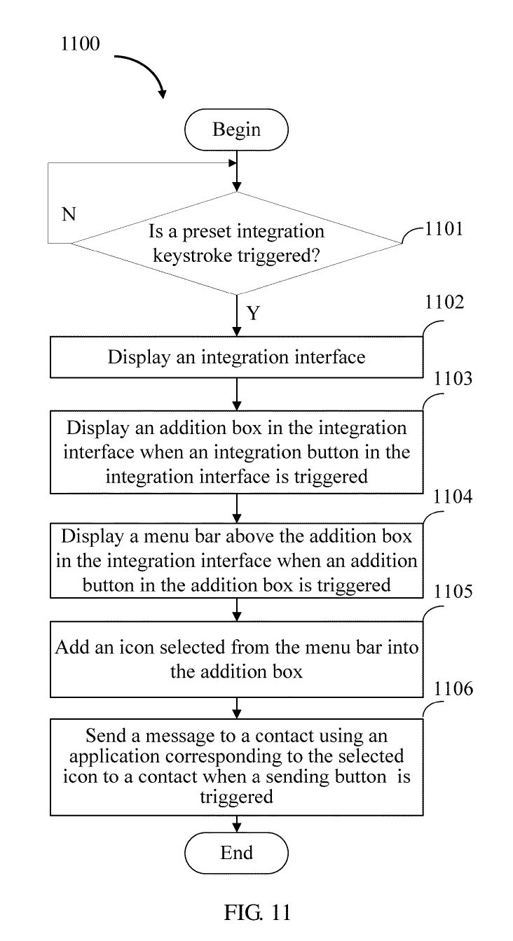

Referring to FIG. 11, a flowchart of a method for sending messages is presented in accordance with an example embodiment. An example method 1100 is provided by way of example, as there are a variety of ways to carry out the method. The example method 1100 described below can be carried out using the configurations illustrated in FIGS. 1-7, for example, and various elements of these figures are referenced in explaining the example method 1100. Each block shown in FIG. 11 represents one or more processes, methods, or subroutines, carried out in the example method 1100. Furthermore, the illustrated order of blocks is illustrative only and the order of the blocks can be changed. Additional blocks can be added or fewer blocks can be utilized without departing from this disclosure. The example method 1100 can begin at block 1101.

At block 1101, a detection module detects whether a preset integration keystroke is triggered. In one embodiment, the preset integration keystroke can be a physical keystroke, a virtual keystroke, or a combination of physical keystroke and the virtual keystroke. When the preset integration keystroke is pressed or clicked, the detection module determines that the preset integration keystroke is triggered, and block 1102 is implemented. Otherwise, if the preset integration keystroke is not triggered, block 1101 is repeated.

At block 1102, a display module displays an integration interface on the touch screen 2. As shown in FIG. 4, the integration interface 40 includes, but is not limited to, a contact area 41, an information displaying window 42, a sending button 43, an integration button 44, and an information input box 45. The user can select a contact from the application 40 to be displayed in the contact area, and further can input a message in the information input box 45 to send to the contact. The information displaying window 42 can display messages transmitted to or received from the contacts.

At block 1103, the display module displays an addition box 46 on the integration interface 40 when the integration button 44 in the integration interface 40 is triggered. The addition box 46 includes an addition button 47.

At block 1104, the display module displays a menu bar 48 above the addition box 46 on the integration interface 40 when the addition button 47 in the addition box 46 is triggered. In at least one embodiment, the menu bar 48 includes the icons 49 of each of the applications.

At block 1105, an addition module adds an icon 49 into the addition box 46 when that icon 49 in the menu bar 48 is selected to be triggered.

At block 1106, a sending module sends a message in the information input box 45 using an application corresponding to the added icon 49 to the contact selected from the contract area when the sending button 43 is triggered.

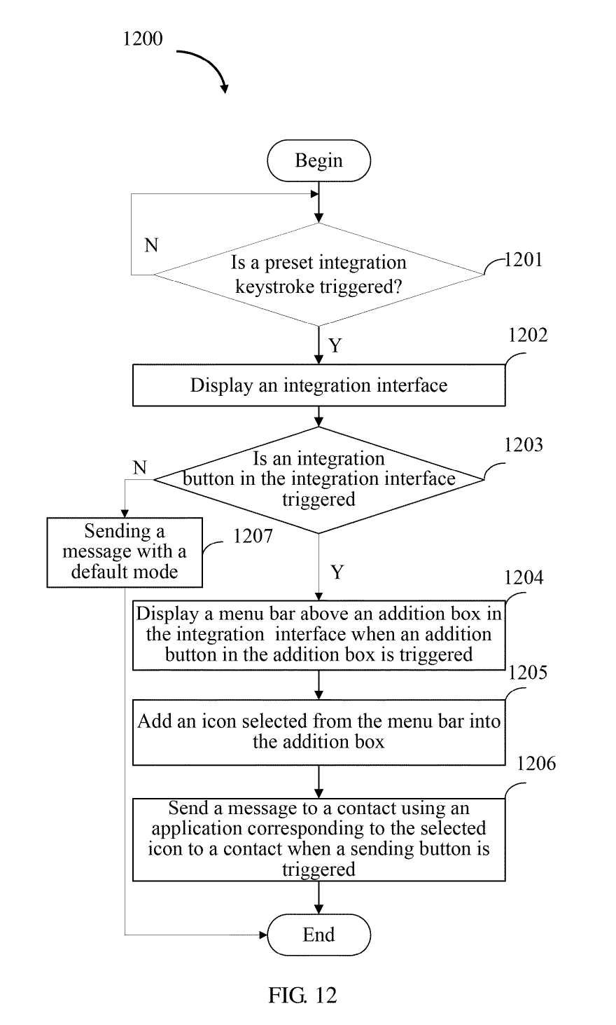

Referring to FIG. 12, a flowchart of a method of replying to messages is presented in accordance with an example embodiment. An example method 1200 is provided by way of example, as there are a variety of ways to carry out the method. The example method 12 described below can be carried out using the configurations illustrated in FIGS. 8-10, for example, and various elements of these figures are referenced in explaining the example method 1200. Each block shown in FIG. 12 represents one or more processes, methods, or subroutines, carried out in the example method 1200. Furthermore, the illustrated order of blocks is illustrative only and the order of the blocks can be changed. Additional blocks can be added or fewer blocks can be utilized without departing from this disclosure. The example method 1200 can begin at block 1201.

At block 1201, when the communication device 1 receives a message from a contact via an application in another communication device, the detection module detects whether the preset integration keystroke is triggered. When the preset integration keystroke is pressed or clicked, the detection module determines that the preset integration keystroke is triggered, and block 1202 is implemented. Otherwise, if the preset integration keystroke is not triggered, block 1201 is repeated.

At block 1202, a display module displays the integration interface on the touch screen 2.

At block 1203, the detection module detects whether the integration button 44 of the integration interface 40 is triggered. If the integration button 44 of the integration interface 40 is triggered, block 1204 is implemented. If the integration button 44 of the integration interface 40 is not triggered, block 1207 is implemented.

At block 1204, the display module displays an addition box 46 including an addition button 47 on the integration interface 40, and the display module displays a menu bar 48 on the integration interface 40 when the addition button 47 is triggered. In at least one embodiment, the menu bar 48 includes the icons 49 of each of the applications.

At block 1205, an addition module adds a particular icon 49 into the addition box 46 when that icon 49 in the menu bar 48 is triggered.

At block 1206, a sending module sends a message in the information input box 45 by way of reply to the contact using the application corresponding to the added icon 49 in the addition box 46 when the sending button 43 is triggered.

At block 1207, the sending module sends the replying message in the information input box 45 in a default mode. In at least one embodiment, the sending module determines which application has sent the latest message displayed on the information displaying window 42, and uses that determined application to send the message in reply.

All of the processes described above can be embodied in, and fully automated via, functional code modules executed by one or more general purpose processors such as the processor 3. The code modules can be stored in any type of non-transitory readable medium or other storage device such as the storage device 4. Some or all of the methods can alternatively be embodied in specialized hardware. Depending on the embodiment, the non-transitory readable medium can be a hard disk drive, a compact disc, a digital versatile disc, a tape drive, or other storage medium.

The described embodiments are merely examples of implementations, and have been set forth for a clear understanding of the principles of the present disclosure. Variations and modifications can be made without departing substantially from the spirit and principles of the present disclosure. All such modifications and variations are intended to be included within the scope of this disclosure and the described inventive embodiments, and the present disclosure is protected by the following claims and their equivalents.

What is claimed is:

1. A communication device comprising:
a touch screen;
at least one processor coupled to the touch screen; and
a storage device coupled to the at least one processor and configured to store one or more programs which, when executed by the at least one processor, cause the at least one processor to:
display an integration interface on the touch screen;
display, when an integration button of the integration interface is triggered, an addition box comprising an addition button on the integration interface;
display, when the addition button in the addition box is triggered, a menu bar on the integration interface, the menu bar comprising a plurality of icons corresponding to a plurality of applications of the communication device;
add an icon selected from the plurality of icons of the menu bar into the addition box;
send, when a sending button of the integration interface is triggered, a message using one of the plurality of applications corresponding to the selected icon to a contact of the one application.

2. The communication device of claim 1, wherein the at least one processor displays the integration interface when a preset integration keystroke is triggered, and wherein the preset integration keystroke is a physical keystroke, a virtual keystroke, or a combination of the physical keystroke and the virtual keystroke.

3. The communication device of claim 1, wherein the integration interface further comprises a contact area, an information displaying window and an information input box.

4. The communication device of claim 3, wherein the contact area displays the contact, the information displaying window displays messages transmitted to or received from the contact, and the information input box displays the message input from the communication device.

5. The communication device of claim 4, wherein the at least one processor further:
determines which application sends the latest message displayed on the information displaying window when the communication device receives one or more message of the contact;
uses the determined application to send the message for replying the contact when the integration button is not triggered and the sending button in the integration interface is triggered.

6. A computer-based method for processing messages of a communication device, the method being executed by at least one processor of the communication device, the method comprising:
displaying an integration interface on a touch screen of the communication device;
displaying, when an integration button in the integration interface is triggered, an addition box comprising an addition button on the integration interface;
displaying, when the addition button in the addition box is triggered, a menu bar on the integration interface, the menu bar comprising a plurality of icons corresponding to a plurality of applications of the communication device;
adding an icon selected from the plurality of icons in the menu bar into the addition box;
sending, when a sending button in the integration interface is triggered, a message using one of the plurality of applications corresponding to the selected icon to a contact of the one application.

7. The method of claim 6, wherein the integration interface is displayed when a preset integration keystroke is triggered, and wherein the preset integration keystroke is a physical keystroke, a virtual keystroke, or a combination of the physical keystroke and the virtual keystroke.

8. The method of claim 6, wherein the integration interface further comprises a contact area, an information displaying window and an information input box.

9. The method of claim 8, wherein the contact area displays the contact, the information displaying window displays messages transmitted to or received from the contact, and the information input box displays the message input from the communication device.

10. The method of claim 9, further comprising:
determining which application sends the latest message displayed on the information displaying window when the communication device receives one or more message of the contact; and
using the determined application to send the message for replying the contact when the integration button is not triggered and the sending button in the integration interface is triggered.

11. A non-transitory computer-readable medium having stored thereon instructions that, when executed by at least one processor of a communication device, causing the communication device to perform a method for processing messages, the method comprising:
displaying an integration interface on a touch screen of the communication device;
displaying, when an integration button in the integration interface is triggered, an addition box comprising an addition button on the integration interface;
displaying, when the addition button in the addition box is triggered, a menu bar on the integration interface, the menu bar comprising a plurality of icons corresponding to a plurality of applications of the communication device;
adding an icon selected from the plurality of icons in the menu bar into the addition box;
sending, when a sending button in the integration interface is triggered, a message using one of the plurality of applications corresponding to the selected icon to a contact of the one application.

12. The non-transitory computer-readable medium of claim 11, wherein the integration interface is displayed when a preset integration keystroke is triggered, and wherein the preset integration keystroke is a physical keystroke, a virtual keystroke, or a combination of the physical keystroke and the virtual keystroke.

13. The non-transitory computer-readable medium of claim 11, wherein the integration interface further comprises a contact area, an information displaying window and an information input box.

14. The non-transitory computer-readable medium of claim 13, wherein the contact area displays the contact, the information displaying window displays messages transmitted to or received from the contact, and the information input box displays the message input from the communication device.

15. The non-transitory computer-readable medium of claim 14, wherein the method further comprises:
determining which application sends the newest message displayed on the information displaying window when the communication device receives one or more message of the contact; and
using the determined application to send the message for replying the contact when the integration button is not triggered and the sending button in the integration interface is triggered.
